(19) United States
(12) Patent Application Publication
(10) Pub. No.: US 2025/0349046 A1
(43) Pub. Date: Nov. 13, 2025

(54) Selecting Color in an Electronic Device Using a Head-Mounted Device

(71) Applicant: Apple Inc., Cupertino, CA (US)

(72) Inventors: Brandon K. Schmuck, San Mateo, CA (US); Anshu K. Chimalamarri, Sunnyvale, CA (US); David Grayson Smith, San Francisco, CA (US)

(21) Appl. No.: 19/196,569

(22) Filed: May 1, 2025

Related U.S. Application Data
(60) Provisional application No. 63/645,619, filed on May 10, 2024.

(51) Int. Cl. G06T 11/00

(52) U.S. Cl. CPC G06T 11/001; G06T 2200/24

(57) ABSTRACT

A head-mounted device may be paired with an external electronic device. During operation of the external electronic device, a user may wish to select a color for a function using a color picker. The user may provide input to the external electronic device to initiate an HMD-based color picker mode where the head-mounted device is used to select a color for the paired external electronic device. The head-mounted device may transmit historical and/or real time color information to the external electronic device in response to the triggering of the HMD-based color picker mode. The user may select a color from the colors provided by the head-mounted device and the selected color may be used for a function on the external electronic device.

This application claims the benefit of U.S. provisional patent application No. 63/645,619, filed May 10, 2024, which is hereby incorporated by reference herein in its entirety.

### BACKGROUND

This relates generally to electronic devices, and, more particularly, to electronic devices with color pickers.

Some electronic devices use a color picker during operation to allow a user to manually select a color from a default list of colors. This type of color picker may be less flexible than desired.

### SUMMARY

An electronic device may include one or more displays, communication circuitry, one or more processors, and memory storing instructions configured to be executed by the one or more processors, the instructions for: in response to a user input, transmitting a request for color information to a head-mounted device using the communication circuitry, receiving the color information from the head-mounted device using the communication circuitry after transmitting the request, and presenting, using the one or more displays, one or more colors based on the color information.

An electronic device may include one or more sensors, communication circuitry, one or more processors, and memory storing instructions configured to be executed by the one or more processors, the instructions for: receiving a request for color information from an external electronic device using the communication circuitry, in accordance with receiving the request for the color information, identifying a color in a physical environment using a first subset of the one or more sensors, and transmitting information regarding the color to the external electronic device using the communication circuitry.

### BRIEF DESCRIPTION OF THE DRAWINGS

FIG. 1 is a schematic diagram of an illustrative system including a head-mounted device and an electronic device in accordance with some embodiments.

FIG. 2 is a view of an illustrative display for an electronic device while the display presents a grid of color for color selection in accordance with some embodiments.

FIG. 3A is a top view of a physical environment that includes an illustrative head-mounted device, an illustrative electronic device, and physical objects in accordance with some embodiments.

FIG. 3B is a view of an illustrative display in the electronic device of FIG. 3A in accordance with some embodiments.

FIG. 3C is a view of an illustrative display in the head-mounted device of FIG. 3A in accordance with some embodiments.

FIG. 4A is a top view of the physical environment of FIG. 3A at a subsequent time in accordance with some embodiments.

FIG. 4B is a view of an illustrative display in the electronic device of FIG. 4A in accordance with some embodiments.

FIG. 4C is a view of an illustrative display in the head-mounted device of FIG. 4A in accordance with some embodiments.

FIG. 5A is a top view of the physical environment of FIGS. 3A and 4A at a subsequent time in accordance with some embodiments.

FIG. 5B is a view of an illustrative display in the electronic device of FIG. 5A in accordance with some embodiments.

FIG. 5C is a view of an illustrative display in the head-mounted device of FIG. 5A in accordance with some embodiments.

FIG. 6A is a view of an illustrative display in the electronic device of FIG. 3A in accordance with some embodiments.

FIG. 6B is a view of an illustrative display in the head-mounted device of FIG. 3A in accordance with some embodiments.

FIG. 7A is a view of an illustrative display in the electronic device of FIG. 4A in accordance with some embodiments.

FIG. 7B is a view of an illustrative display in the head-mounted device of FIG. 4A in accordance with some embodiments.

FIG. 8A is a view of an illustrative display in the electronic device of FIG. 5A in accordance with some embodiments.

FIG. 8B is a view of an illustrative display in the head-mounted device of FIG. 5A in accordance with some embodiments.

FIG. 9 is a view of an illustrative display in an electronic device that presents historical color information in accordance with some embodiments.

FIG. 10 is a view of an illustrative display in an electronic device that presents user interface elements of different sizes with different colors in accordance with some embodiments.

FIG. 11 is a flowchart of an illustrative method for operating an electronic device that is paired with a head-mounted device in accordance with some embodiments.

FIG. 12 is a flowchart of an illustrative method for operating a head-mounted device that is paired with an electronic device in accordance with some embodiments.

### DETAILED DESCRIPTION

Head-mounted devices may display different types of extended reality content for a user. The head-mounted device may display a virtual object that is perceived at an apparent depth within the physical environment of the user. Virtual objects may sometimes be displayed at fixed locations relative to the physical environment of the user. For example, consider an example where a user's physical environment includes a table. A virtual object may be displayed for the user such that the virtual object appears to be resting on the table. As the user moves their head and otherwise interacts with the XR environment, the virtual object remains at the same, fixed position on the table (e.g., as if the virtual object were another physical object in the XR environment). This type of content may be referred to as world-locked content (because the position of the virtual object is fixed relative to the physical environment of the user).

Other virtual objects may be displayed at locations that are defined relative to the head-mounted device or a user of the head-mounted device. First, consider the example of virtual objects that are displayed at locations that are defined relative to the head-mounted device. As the head-mounted device moves (e.g., with the rotation of the user's head), the virtual object remains in a fixed position relative to the head-mounted device. For example, the virtual object may be displayed in the front and center of the head-mounted device (e.g., in the center of the device's or user's field-of-view) at a particular distance. As the user moves their head left and right, their view of their physical environment changes accordingly. However, the virtual object may remain fixed in the center of the device's or user's field of view at the particular distance as the user moves their head (assuming gaze direction remains constant). This type of content may be referred to as head-locked content. The head-locked content is fixed in a given position relative to the head-mounted device (and therefore the user's head which is supporting the head-mounted device). The head-locked content may not be adjusted based on a user's gaze direction. In other words, if the user's head position remains constant and their gaze is directed away from the head-locked content, the head-locked content will remain in the same apparent position.

Second, consider the example of virtual objects that are displayed at locations that are defined relative to a portion of the user of the head-mounted device (e.g., relative to the user's torso). This type of content may be referred to as body-locked content. For example, a virtual object may be displayed in front and to the left of a user's body (e.g., at a location defined by a distance and an angular offset from a forward-facing direction of the user's torso), regardless of which direction the user's head is facing. If the user's body is facing a first direction, the virtual object will be displayed in front and to the left of the user's body. While facing the first direction, the virtual object may remain at the same, fixed position relative to the user's body in the XR environment despite the user rotating their head left and right (to look towards and away from the virtual object). However, the virtual object may move within the device's or user's field of view in response to the user rotating their head. If the user turns around and their body faces a second direction that is the opposite of the first direction, the virtual object will be repositioned within the XR environment such that it is still displayed in front and to the left of the user's body. While facing the second direction, the virtual object may remain at the same, fixed position relative to the user's body in the XR environment despite the user rotating their head left and right (to look towards and away from the virtual object).

In the aforementioned example, body-locked content is displayed at a fixed position/orientation relative to the user's body even as the user's body rotates. For example, the virtual object may be displayed at a fixed distance in front of the user's body. If the user is facing north, the virtual object is in front of the user's body (to the north) by the fixed distance. If the user rotates and is facing south, the virtual object is in front of the user's body (to the south) by the fixed distance.

Alternatively, the distance offset between the body-locked content and the user may be fixed relative to the user whereas the orientation of the body-locked content may remain fixed relative to the physical environment. For example, the virtual object may be displayed in front of the user's body at a fixed distance from the user as the user faces north. If the user rotates and is facing south, the virtual object remains to the north of the user's body at the fixed distance from the user's body.

Body-locked content may also be configured to always remain gravity or horizon aligned, such that head and/or body changes in the roll orientation would not cause the body-locked content to move within the XR environment. Translational movement may cause the body-locked content to be repositioned within the XR environment to maintain the fixed distance from the user. Subsequent descriptions of body-locked content may include both of the aforementioned types of body-locked content.

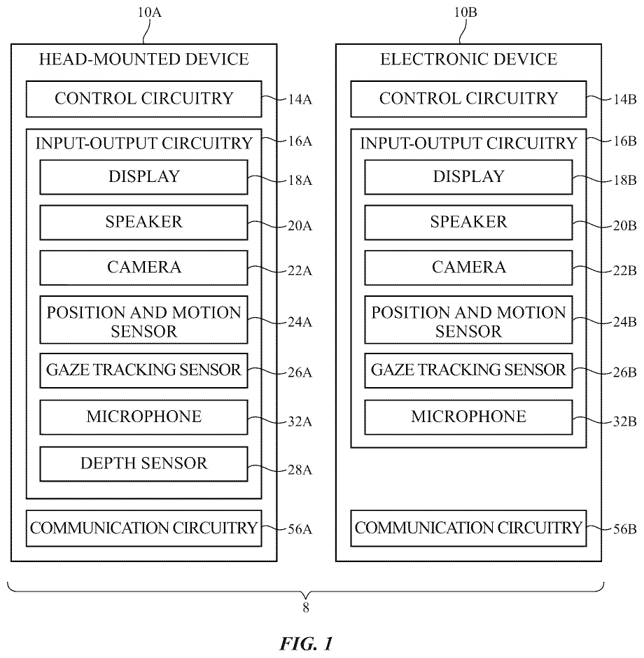

A schematic diagram of an illustrative system having a head-mounted device and an electronic device is shown in FIG. 1. As shown in FIG. 1, system 8 may include one or more electronic devices such as electronic device 10A and electronic device 10B. The electronic devices of system 8 may include computers such as laptop computers, cellular telephones, head-mounted devices, wristwatch devices, tablet computers, earbuds, a display with a wired connection to a computer, and other electronic devices. Configurations in which electronic device 10A is a head-mounted device and electronic device 10B is a laptop computer are described herein as an example.

As shown in FIG. 1, electronic device 10A (sometimes referred to as head-mounted device 10A, system 10A, head-mounted display 10A, etc.) may have control circuitry 14A. In addition to being a head-mounted device, electronic device 10A may be other types of electronic devices such as a cellular telephone, laptop computer, speaker, computer monitor, electronic watch, tablet computer, etc.

Control circuitry 14A may be configured to perform operations in head-mounted device 10A using hardware (e.g., dedicated hardware or circuitry), firmware and/or software. Software code for performing operations in head-mounted device 10A and other data is stored on non-transitory computer readable storage media (e.g., tangible computer readable storage media) in control circuitry 14A. The software code may sometimes be referred to as software, data, program instructions, instructions, or code. The non-transitory computer readable storage media (sometimes referred to generally as memory) may include non-volatile memory such as non-volatile random-access memory (NVRAM), one or more hard drives (e.g., magnetic drives or solid-state drives), one or more removable flash drives or other removable media, or the like. Software stored on the non-transitory computer readable storage media may be executed on the processing circuitry of control circuitry 14A. The processing circuitry may include application-specific integrated circuits with processing circuitry, one or more microprocessors, digital signal processors, graphics processing units, a central processing unit (CPU) or other processing circuitry.

Head-mounted device 10A may include input-output circuitry 16A. Input-output circuitry 16A may be used to allow a user to provide head-mounted device 10A with user input. Input-output circuitry 16A may also be used to gather information on the environment in which head-mounted device 10A is operating. Output components in circuitry 16A may allow head-mounted device 10A to provide a user with output.

As shown in FIG. 1, input-output circuitry 16A may include a display such as display 18A. Display 18A may be used to display images for a user of head-mounted device 10A. Display 18A may be a transparent or translucent display so that a user may observe physical objects through the display while computer-generated content is overlaid on top of the physical objects by presenting computer-generated images on the display. A transparent or translucent display may be formed from a transparent or translucent pixel array (e.g., a transparent organic light-emitting diode display panel) or may be formed by a display device that provides images to a user through a transparent structure such as a beam splitter, holographic coupler, or other optical coupler (e.g., a display device such as a liquid crystal on silicon display). Alternatively, display 18A may be an opaque display that blocks light from physical objects when a user operates head-mounted device 10A. In this type of arrangement, a pass-through camera may be used to display physical objects to the user. The pass-through camera may capture images of the physical environment and the physical environment images may be displayed on the display for viewing by the user. Additional computer-generated content (e.g., text, game-content, other visual content, etc.) may optionally be overlaid over the physical environment images to provide an extended reality environment for the user. When display 18A is opaque, the display may also optionally display entirely computer-generated content (e.g., without displaying images of the physical environment).

Display 18A may include one or more optical systems (e.g., lenses) (sometimes referred to as optical assemblies) that allow a viewer to view images on display(s) 18A. A single display 18A may produce images for both eyes or a pair of displays 18A may be used to display images. In configurations with multiple displays (e.g., left and right eye displays), the focal length and positions of the lenses may be selected so that any gap present between the displays will not be visible to a user (e.g., so that the images of the left and right displays overlap or merge seamlessly). Display modules (sometimes referred to as display assemblies) that generate different images for the left and right eyes of the user may be referred to as stereoscopic displays. The stereoscopic displays may be capable of presenting two-dimensional content (e.g., a user notification with text) and three-dimensional content (e.g., a simulation of a physical object such as a cube).

Display 18A may include an organic light-emitting diode display or other displays based on arrays of light-emitting diodes, a liquid crystal display, a liquid-crystal-on-silicon display, a projector or display based on projecting light beams on a surface directly or indirectly through specialized optics (e.g., digital micromirror devices), an electrophoretic display, a plasma display, an electrowetting display, or any other desired display.

Input-output circuitry 16A may include various other input-output devices. For example, input-output circuitry 16A may include one or more speakers 20A that are configured to play audio and/or one or more microphones 32A that are configured to capture audio data from the user and/or from the physical environment around the user.

Input-output circuitry 16A may include one or more cameras 22A. Cameras 22A may include one or more outward-facing cameras (that face the physical environment around the user when the electronic device is mounted on the user's head, as one example). Cameras 22A may capture visible light images, infrared images, or images of any other desired type. The cameras may be stereo cameras if desired. Outward-facing cameras may capture pass-through video for device 10. Cameras 22A may also include inward-facing cameras (e.g., for gaze detection).

As shown in FIG. 1, input-output circuitry 16A may include position and motion sensors 24A (e.g., compasses, gyroscopes, accelerometers, and/or other devices for monitoring the location, orientation, and movement of electronic device 10, satellite navigation system circuitry such as Global Positioning System circuitry for monitoring user location, etc.). Using sensors 24A, for example, control circuitry 14A can monitor the current direction in which a user's head is oriented relative to the surrounding environment (e.g., a user's head pose). The cameras in cameras 22A may also be considered part of position and motion sensors 24A. The cameras may be used for face tracking (e.g., by capturing images of the user's jaw, mouth, etc. while the device is worn on the head of the user), body tracking (e.g., by capturing images of the user's torso, arms, hands, legs, etc. while the device is worn on the head of user), and/or for localization (e.g., using visual odometry, visual inertial odometry, or other simultaneous localization and mapping (SLAM) technique).

Input-output circuitry 16A may include a gaze-tracking sensor 26A (sometimes referred to as gaze-tracker 26A, gaze-tracking system 26A, gaze detection sensor 26A, etc.). The gaze-tracking sensor 26A may include a camera and/or other gaze-tracking sensor components (e.g., light sources that emit beams of light so that reflections of the beams from a user's eyes may be detected) to monitor the user's eyes. Gaze-tracker 26A may face a user's eyes and may track a user's gaze. A camera in the gaze-tracking system may determine the location of a user's eyes (e.g., the centers of the user's pupils), may determine the direction in which the user's eyes are oriented (the direction of the user's gaze), may determine the user's pupil size (e.g., so that light modulation and/or other optical parameters and/or the amount of gradualness with which one or more of these parameters is spatially adjusted and/or the area in which one or more of these optical parameters is adjusted based on the pupil size), may be used in monitoring the current focus of the lenses in the user's eyes (e.g., whether the user is focusing in the near field or far field, which may be used to assess whether a user is day dreaming or is thinking strategically or tactically), and/or other gaze information. Cameras in the gaze-tracking system may sometimes be referred to as inward-facing cameras, gaze-detection cameras, eye-tracking cameras, gaze-tracking cameras, or eye-monitoring cameras. If desired, other types of image sensors (e.g., infrared and/or visible light-emitting diodes and light detectors, etc.) may also be used in monitoring a user's gaze. The use of a gaze-detection camera in gaze-tracker 26A is merely illustrative.

Input-output circuitry 16 may include one or more depth sensors 28A. Each depth sensor may be a pixelated depth sensor (e.g., that is configured to measure multiple depths across the physical environment) or a point sensor (that is configured to measure a single depth in the physical environment). Each depth sensor (whether a pixelated depth sensor or a point sensor) may use phase detection (e.g., phase detection autofocus pixel(s)) or light detection and ranging (LIDAR) to measure depth. Camera images (e.g., from one of cameras 22) may also be used for monocular and/or stereo depth estimation. Any combination of depth sensors may be used to determine the depth of physical objects in the physical environment.

Input-output circuitry 16A may also include other sensors and input-output components if desired (e.g., ambient light sensors, force sensors, temperature sensors, touch sensors, buttons, capacitive proximity sensors, light-based proximity sensors, other proximity sensors, strain gauges, gas sensors, pressure sensors, moisture sensors, magnetic sensors, audio components, haptic output devices such as actuators and/or vibration motors, light-emitting diodes, other light sources, etc.).

Head-mounted device 10A may also include communication circuitry 56A to allow the head-mounted device to communicate with external equipment (e.g., a tethered computer, a portable device such as electronic device 10B, one or more external servers, or other electrical equipment). Communication circuitry 56A may be used for both wired and wireless communication with external equipment.

Communication circuitry 56A may include radio-frequency (RF) transceiver circuitry formed from one or more integrated circuits, power amplifier circuitry, low-noise input amplifiers, passive RF components, one or more antennas, transmission lines, and other circuitry for handling RF wireless signals. Wireless signals can also be sent using light (e.g., using infrared communications).

The radio-frequency transceiver circuitry in wireless communications circuitry 56A may handle wireless local area network (WLAN) communications bands such as the 2.4 GHz and 5 GHz Wi-Fi® (IEEE 802.11) bands, wireless personal area network (WPAN) communications bands such as the 2.4 GHz Bluetooth® communications band, cellular telephone communications bands such as a cellular low band (LB) (e.g., 600 to 960 MHz), a cellular low-midband (LMB) (e.g., 1400 to 1550 MHZ), a cellular midband (MB) (e.g., from 1700 to 2200 MHz), a cellular high band (HB) (e.g., from 2300 to 2700 MHZ), a cellular ultra-high band (UHB) (e.g., from 3300 to 5000 MHz, or other cellular communications bands between about 600 MHz and about 5000 MHz (e.g., 3G bands, 4G LTE bands, 5G New Radio Frequency Range 1 (FR1) bands below 10 GHz, etc.), a near-field communications (NFC) band (e.g., at 13.56 MHz), satellite navigations bands (e.g., an L1 global positioning system (GPS) band at 1575 MHz, an L5 GPS band at 1176 MHz, a Global Navigation Satellite System (GLONASS) band, a BeiDou Navigation Satellite System (BDS) band, etc.), ultra-wideband (UWB) communications band(s) supported by the IEEE 802.15.4 protocol and/or other UWB communications protocols (e.g., a first UWB communications band at 6.5 GHz and/or a second UWB communications band at 8.0 GHZ), and/or any other desired communications bands.

The radio-frequency transceiver circuitry may include millimeter/centimeter wave transceiver circuitry that supports communications at frequencies between about 10 GHz and 300 GHz. For example, the millimeter/centimeter wave transceiver circuitry may support communications in Extremely High Frequency (EHF) or millimeter wave communications bands between about 30 GHz and 300 GHz and/or in centimeter wave communications bands between about 10 GHz and 30 GHz (sometimes referred to as Super High Frequency (SHF) bands). As examples, the millimeter/centimeter wave transceiver circuitry may support communications in an IEEE K communications band between about 18 GHz and 27 GHz, a Kₐ communications band between about 26.5 GHz and 40 GHz, a Kᵤ communications band between about 12 GHz and 18 GHz, a V communications band between about 40 GHz and 75 GHz, a W communications band between about 75 GHz and 110 GHz, or any other desired frequency band between approximately 10 GHz and 300 GHz. If desired, the millimeter/centimeter wave transceiver circuitry may support IEEE 802.11ad communications at 60 GHz (e.g., WiGig or 60 GHz Wi-Fi bands around 57-61 GHz), and/or 5^{th} generation mobile networks or 5^{th} generation wireless systems (5G) New Radio (NR) Frequency Range 2 (FR2) communications bands between about 24 GHz and 90 GHz.

Antennas in wireless communications circuitry 56A may include antennas with resonating elements that are formed from loop antenna structures, patch antenna structures, inverted-F antenna structures, slot antenna structures, planar inverted-F antenna structures, helical antenna structures, dipole antenna structures, monopole antenna structures, hybrids of these designs, etc. Different types of antennas may be used for different bands and combinations of bands. For example, one type of antenna may be used in forming a local wireless link and another type of antenna may be used in forming a remote wireless link antenna.

Electronic device 10B may be communicatively coupled with electronic device 10A. In other words, a wireless link may be established directly or indirectly between electronic devices 10A and 10B to allow communication between devices 10A and 10B. Electronic devices 10A and 10B may be associated with the same user (e.g., signed into a cloud service using the same user ID), may exchange wireless communications, etc. As previously described, electronic device 10A may be a head-mounted device whereas electronic device 10B may be an electronic device such as a cellular telephone, watch, laptop computer, earbuds, etc.

Electronic device 10B may include control circuitry 14B, input-output circuitry 16B, display 18B, speaker 20B, camera 22B, position and motion sensors 24B, gaze tracking sensor 26B, microphone 32B, and communication circuitry 56B. Control circuitry 14B, input-output circuitry 16B, display 18B, speaker 20B, camera 22B, position and motion sensors 24B, gaze tracking sensor 26B, microphone 32B, and communication circuitry 56B may have the same features and capabilities as the corresponding components in electronic device 10A and, for simplicity, the descriptions thereof will not be repeated. It is noted that display 18B may include an organic light-emitting diode display or other displays based on arrays of light-emitting diodes, a liquid crystal display, a liquid-crystal-on-silicon display, a projector or display based on projecting light beams on a surface directly or indirectly through specialized optics (e.g., digital micromirror devices), an electrophoretic display, a plasma display, an electrowetting display, or any other desired display.

In the event that electronic device 10B is a cellular telephone or tablet computer, electronic device 10B may have a housing and display 18B may form a front face of the electronic device within the housing. In the event that electronic device 10B is a watch, electronic device 10B may have a housing, display 18B may form a front face of the electronic device within the housing, and a wristwatch strap may extend from first and second opposing sides of the housing. In the event that electronic device 10B is a laptop computer, electronic device 10B may have a lower housing with a keyboard and/or touchpad and an upper housing with a display. The lower housing and the upper housing may be coupled at a hinge such that the upper housing rotates relative to the lower housing to open and close the laptop computer.

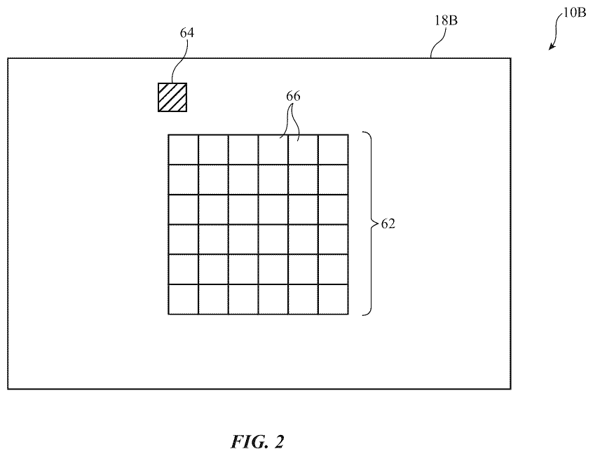

In some cases, a user operating electronic device 10B may wish to select a color for a function in electronic device 10B. For example, the user may wish to select a color for a drawing tool, may wish to select a color for a selected shape, may wish to select a color for selected text, may wish to select a color for new text, etc. When a user wishes to select a color while operating electronic device 10B, a grid of colors may be presented on display 18B. FIG. 2 is a view of display 18B while the display presents a grid of color for color selection.

Grid 62 in FIG. 2 may include a plurality of squares 66 that each have a unique color. The user may select one of the squares using a touch input or mouse click. The color of the selected square may then be used for a function in electronic device 10B. The interface for selecting a color showed in FIG. 2 may be referred to as a color picker or as a color picker user interface.

Providing a color picker user interface that includes a grid with different colors may allow for the user to pick one of the default colors associated with squares 66. However, in some cases the user may wish to select a color in their physical environment. To enable the user to easily select a color with the color picker that matches a color in their physical environment, electronic device 10B may communicate with a paired head-mounted device 10A.

As shown in FIG. 2, when electronic device 10B is paired with a head-mounted device 10A, the color picker user interface may include a user interface element 64 that is associated with the selection of color from the physical environment using head-mounted device 10A. User interface element 64 may be an icon or other affordance. The user may provide user input to electronic device 10B to select user interface element 64. As examples, the user may touch user interface element 64 on a touch sensitive display or may click the user interface element using a mouse.

Selecting user interface element 64 may trigger a head-mounted-device-based color picker mode. In the HMD-based color picker mode, head-mounted device 10A is used to select a color. A user interface may be presented on display 18B of electronic device 10B and/or on display 18A of electronic device 10A to assist the user in selecting a color from their physical environment.

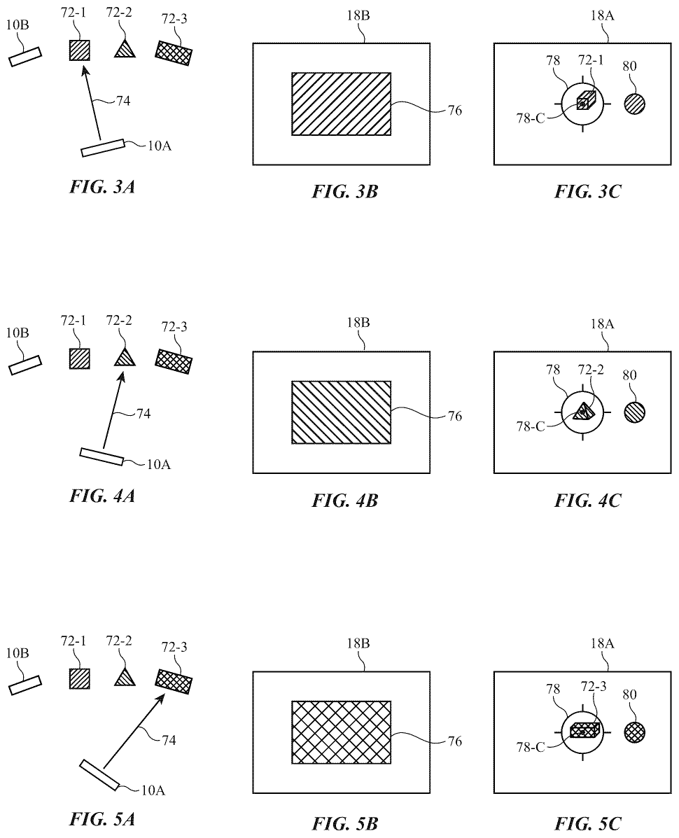

FIGS. 3A-3C, FIGS. 4A-4C and FIGS. 5A-5C show operation of head-mounted device 10A and electronic device 10B while in an HMD-based color picker mode. FIGS. 3A, 4A, and 5A are top views of an illustrative physical environment that includes head-mounted device 10A, electronic device 10B, and physical objects. FIG. 3B is a view of display 18B in electronic device 10B of FIG. 3A. FIG. 4B is a view of display 18B in electronic device 10B of FIG. 4A. FIG. 5B is a view of display 18B in electronic device 10B of FIG. 5A. FIG. 3C is a view of display 18A in head-mounted device 10A of FIG. 3A. FIG. 4C is a view of display 18A in head-mounted device 10A of FIG. 4A. FIG. 5C is a view of display 18A in head-mounted device 10A of FIG. 5A.

As shown in FIGS. 3A, 4A, and 5A the physical environment may include electronic device 10B, head-mounted device 10A (which may be worn on the head of the user), and physical objects 72-1, 72-2, and 72-3. Physical objects 72-1, 72-2, and 72-3 may be different colors. As an example, physical object 72-1 is red, physical object 72-2 is green, and physical object 72-3 is blue. In FIG. 3A, head-mounted device 10A (and the user's head) may face direction 74 towards physical object 72-1. In FIG. 4A, at a subsequent time, head-mounted device 10A (and the user's head) may face direction 74 towards physical object 72-2. In FIG. 5A, at a subsequent time, head-mounted device 10A (and the user's head) may face direction 74 towards physical object 72-3.

FIG. 3C shows display 18A on head-mounted device 10A while the user faces physical object 72-1. As shown in FIG. 3C, physical object 72-1 may be visible on display 18A. In embodiments where display 18A is transparent, physical object 72-1 may be visible through the transparent display. In embodiments where display 18A is opaque, an image of physical object 72-1 may be captured by one or more cameras 22A and presented on display 18A (e.g., via passthrough video).

Visual indicator 78 may also be visible on display 18A. The visual indicator 78 may be a head-locked visual indicator that is locked in the center of display 18A (as one example). The visible indicator may identify a color that is currently being targeted/sampled by head-mounted device 10A for the HMD-based color picker. Visual indicator 78 may sometimes be referred to as reticle 78, target 78, alignment indicator 78, etc. In general, visual indicator 78 may have any desired shape or appearance that identifies a subset of the physical environment as being targeted for color sampling.

In FIG. 3C, the center 78-C of alignment indicator 78 is aligned with physical object 72-1. The physical object 72-1 is therefore being targeted for color sampling. To show to the user the color currently being targeted by reticle 78, a user interface element 80 may be presented adjacent to visual indicator 78. User interface element 80 may be a shape (e.g., a circle) that is filled with the color targeted by reticle 78. In the example of FIG. 3C, reticle 78 is aligned with red physical object 72-1. One or more cameras 22A determine that the color being targeted by the reticle is red. The user interface element 80 is therefore presented with a red color.

In addition to presenting user interface element 80 identifying the color currently being sampled, head-mounted device 10A may transmit the color currently being sampled to electronic device 10B. As shown in FIG. 3B, display 18B of electronic device 10B may present a user interface element 76 that is filled with the color targeted by reticle 78 in head-mounted device 10A. In the example of FIG. 3B, the user interface element 76 is therefore presented with a red color.

After the head-mounted device 10A faces physical object 72-1 in FIG. 3A, the head-mounted device 10A may turn to face physical object 72-2 in FIG. 4A. FIG. 4C shows display 18A on head-mounted device 10A while the user faces physical object 72-2. As shown in FIG. 4C, physical object 72-2 may be visible on display 18A. In embodiments where display 18A is transparent, physical object 72-2 may be visible through the transparent display. In embodiments where display 18A is opaque, an image of physical object 72-2 may be captured by one or more cameras 22A and presented on display 18A (e.g., via passthrough video).

Visual indicator 78 may also be visible on display 18A in FIG. 4C. In the example of FIG. 4C, reticle 78 is aligned with green physical object 72-2. One or more cameras 22A determine that the color being targeted by the reticle is green. The user interface element 80 is therefore presented with a green color. In the example of FIG. 4B, the user interface element 76 is also presented with the green color.

After the head-mounted device 10A faces physical object 72-2 in FIG. 4A, the head-mounted device 10A may turn to face physical object 72-3 in FIG. 5A. FIG. 5C shows display 18A on head-mounted device 10A while the user faces physical object 72-3. As shown in FIG. 5C, physical object 72-3 may be visible on display 18A. In embodiments where display 18A is transparent, physical object 72-3 may be visible through the transparent display. In embodiments where display 18A is opaque, an image of physical object 72-3 may be captured by one or more cameras 22A and presented on display 18A (e.g., via passthrough video).

Visual indicator 78 may also be visible on display 18A in FIG. 5C. In the example of FIG. 5C, reticle 78 is aligned with blue physical object 72-3. One or more cameras 22A determine that the color being targeted by the reticle is blue. The user interface element 80 is therefore presented with a blue color. In the example of FIG. 5B, the user interface element 76 is also presented with the blue color.

In the example of FIGS. 3-5, head-mounted device 10B may continuously transmit a single color that is targeted by alignment indicator 78. The color targeted by alignment indicator 78 is displayed in real time via user interface element 80 on display 18A and via user interface element 76 on display 18B. The color being targeted by alignment indicator 78 may be referred to as the color being sampled by head-mounted device 10A. Information from depth sensor 28A may optionally be used to determine the color being targeted by alignment indicator 78. The color being sampled by head-mounted device 10A may be transmitted to electronic device 10B at a fixed frequency (e.g., once per second, once per 0.1 seconds, etc.) or whenever the sampled color changes.

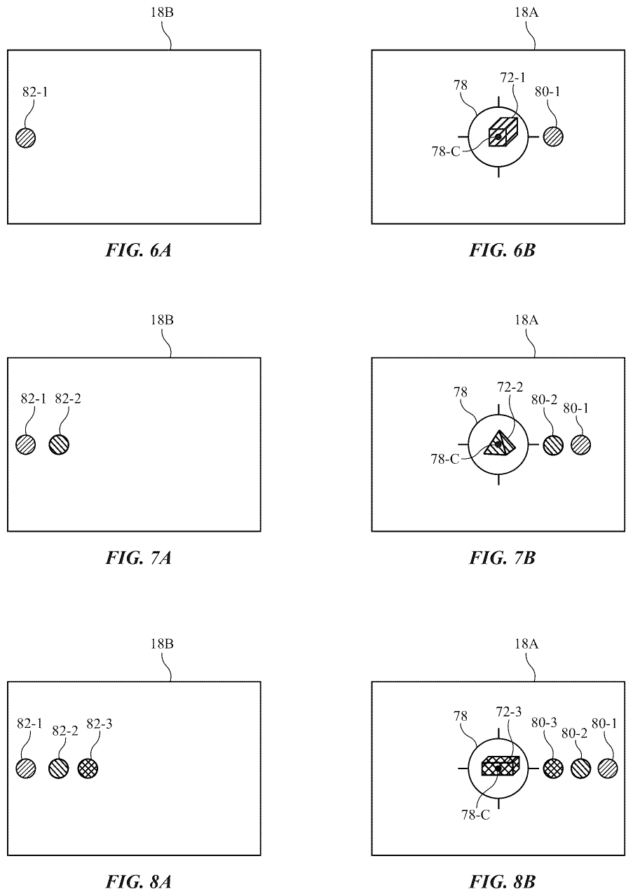

The example in FIGS. 3-5 of presenting one sampled color at a time on displays 18A and 18B is merely illustrative. In another possible arrangement, shown in FIGS. 6-8, multiple sampled colors are simultaneously presented on displays 18A and 18B.

FIGS. 6-8 show illustrative user interfaces on displays 18A and 18B for the physical environments of FIGS. 3A, 4A, and 5A, respectively. FIG. 6A is a view of display 18B in electronic device 10B of FIG. 3A. FIG. 7A is a view of display 18B in electronic device 10B of FIG. 4A. FIG. 8A is a view of display 18B in electronic device 10B of FIG. 5A. FIG. 6B is a view of display 18A in head-mounted device 10A of FIG. 3A. FIG. 7B is a view of display 18A in head-mounted device 10A of FIG. 4A. FIG. 8B is a view of display 18A in head-mounted device 10A of FIG. 5A.

FIG. 6B shows display 18A on head-mounted device 10A while the user faces physical object 72-1. As shown in FIG. 6B, physical object 72-1 may be visible on display 18A. In embodiments where display 18A is transparent, physical object 72-1 may be visible through the transparent display. In embodiments where display 18A is opaque, an image of physical object 72-1 may be captured by one or more cameras 22A and presented on display 18A (e.g., via passthrough video).

Similar to as discussed in connection with FIGS. 3C, 4C, and 5C, visual indicator 78 may also be visible on display 18A. In FIG. 6B, the center of visual indicator 78 is aligned with physical object 72-1. The physical object 72-1 is therefore being targeted for color sampling. To show to the user the color currently being targeted by reticle 78, a user interface element 80-1 may be presented adjacent to visual indicator 78. User interface element 80-1 may be a shape (e.g., a circle) that is filled with the color targeted by reticle 78. In the example of FIG. 6B, reticle 78 is aligned with red physical object 72-1. One or more cameras 22A determine that the color being targeted by the reticle is red. The user interface element 80-1 is therefore presented on display 18A with a red color.

In addition to presenting user interface element 80-1 identifying the color currently being sampled, head-mounted device 10A may transmit the color currently being sampled to electronic device 10B. As shown in FIG. 6A, display 18B of electronic device 10B may present a user interface element 82-1 that is filled with the color targeted by reticle 78 in head-mounted device 10A. In the example of FIG. 6A, the user interface element 82-1 is therefore presented on display 18B with a red color.

After the head-mounted device 10A faces physical object 72-1 in FIG. 3A, the head-mounted device 10A may turn to face physical object 72-2 in FIG. 4A. FIG. 7B shows display 18A on head-mounted device 10A while the user faces physical object 72-2. As shown in FIG. 7B, physical object 72-2 may be visible on display 18A. In embodiments where display 18A is transparent, physical object 72-2 may be visible through the transparent display. In embodiments where display 18A is opaque, an image of physical object 72-2 may be captured by one or more cameras 22A and presented on display 18A (e.g., via passthrough video).

Visual indicator 78 may also be visible on display 18A in FIG. 7B. In the example of FIG. 7B, reticle 78 is aligned with green physical object 72-2. One or more cameras 22A determine that the color being targeted by the reticle is green. A new user interface element 80-2 is therefore presented on display 18A with a green color in addition to the red user interface element 80-1 from FIG. 6B. Similarly, on display 18B in FIG. 7A, a new user interface element 82-2 is presented with the green color in addition to the red user interface element 82-1 from FIG. 6A.

After the head-mounted device 10A faces physical object 72-2 in FIG. 4A, the head-mounted device 10A may turn to face physical object 72-3 in FIG. 5A. FIG. 8B shows display 18A on head-mounted device 10A while the user faces physical object 72-3. As shown in FIG. 8B, physical object 72-3 may be visible on display 18A. In embodiments where display 18A is transparent, physical object 72-3 may be visible through the transparent display. In embodiments where display 18A is opaque, an image of physical object 72-3 may be captured by one or more cameras 22A and presented on display 18A (e.g., via passthrough video).

Visual indicator 78 may also be visible on display 18A in FIG. 8B. In the example of FIG. 8B, reticle 78 is aligned with blue physical object 72-3. One or more cameras 22A determine that the color being targeted by the reticle is blue. A new user interface element 80-3 is therefore presented on display 18A with a blue color in addition to the red and green user interface element 80-1 and 80-2 from FIG. 7B. Similarly, on display 18B in FIG. 8A, a new user interface element 82-3 is presented with the blue color in addition to the red and green user interface elements 82-1 and 82-2 from FIG. 7A.

To summarize, in FIGS. 6-8 an ongoing list of colors sampled during the HMD-based color picker mode is presented on displays 18A and/or 18B. On display 18A, sampled colors may be presented as user interface elements 80, with multiple user interface elements 80 of different colors simultaneously being presented on display 18A. On display 18B, sampled colors may be presented as user interface elements 82, with multiple user interface elements 82 of different colors simultaneously being presented on display 18B.

In the example of FIGS. 6B, 7B, and 8B, a new user interface element is presented adjacent to visual indicator 78 and any previous user interface elements are slid over to accommodate the new user interface element (such that the new user interface element is interposed between visual indicator 78 and the old user interface elements). This scheme is merely illustrative and in general the user interface elements may be presented on display 18A in any desired manner. If desired, there may be a maximum number of user interface elements that are presented on display 18A. For example, only six user interface elements may be presented on display 18A. If a seventh color is sampled in the HMD-based color picker mode, the user interface element associated with the oldest sampled color may no longer be presented (e.g., with the newest sampled color taking its spot).

In the example of FIGS. 6A, 7A, and 8A, a new user interface element is presented adjacent to the existing user interface elements such that the position of a user interface element is fixed. This scheme is merely illustrative and in general the user interface elements may be presented on display 18B in any desired manner.

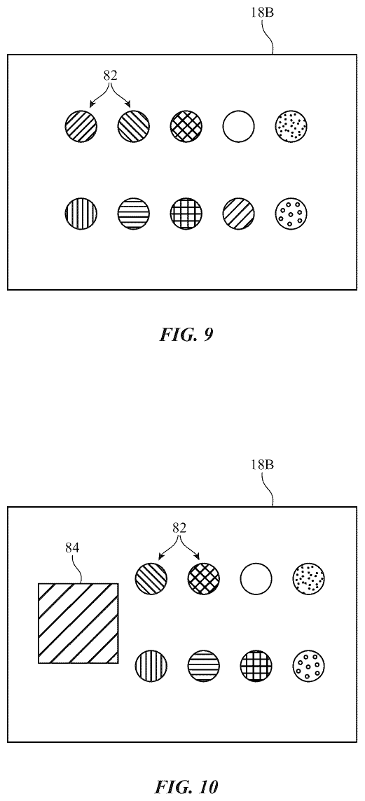

In the HMD-based color picker mode, historical colors sampled by cameras 22A in head-mounted device 10A may be presented on display 18A and/or display 18B instead of or in addition to colors sampled after the HMD-based color picker mode is triggered. FIG. 9 shows an example where, after the HMD-based color picker mode is triggered, head-mounted device 10A transmits ten recently identified colors to electronic device 10B. The ten recently identified colors may have been identified before the HMD-based color picker mode was triggered and therefore may be referred to as historical color samples or historical color information. Display 18B may present user interface elements 82 that each have one of the colors of the historical color samples received from head-mounted device 10A.

If desired, regardless of whether display 18B is presenting historical color samples of real-time color samples, display 18B may present one user interface element 84 that is larger than the remaining user interface elements 82. As one example, the large user interface element 84 may have a color that is determined by HMD 10A to be the most common color in the physical environment. The most common color may be considered the color that is sampled the most often or for the longest period of time, the color that occupies the largest area in the physical environment, etc. As another example, the large user interface element 84 may be a color that is the most recent color sampled by HMD 10A.

It is noted that the head-locked visual indicator shown in FIGS. 3-8 is merely illustrative. If desired, the head-locked visual indicator may instead be gaze-locked (such that the reticle is focused on the user's point of gaze). A color may optionally only be sampled when the dwell time of the visual indicator on the given color is greater than a threshold time period (e.g., 200 milliseconds, 1 second, etc.). This may improve the user experience by preventing transient colors from dominating the list of sampled colors.

Head-mounted device 10A may use images from camera 22A, depth information from depth sensor 28A, and/or ray tracing procedures to determine the color that is aligned with visual indicator 78.

At any time during operation of the HMD-based color picker, the user may provide input to select one of the sampled colors. In the example of FIGS. 3-5, only one sampled color is presented at a time. The user may therefore provide input selecting the color that is currently being sampled/presented. The input may be provided to electronic device 10B and/or HMD 10A. When the input is provided to electronic device 10B, the input may be a touch input (e.g., a touch on a touch-sensitive display), a mouse click, a keyboard press, a verbal command (e.g., detected by microphone 32B), a motion gesture (e.g., detected by position and motion sensors 24B), etc. When the input is provided to HMD 10A, the input may be a touch input (e.g., a touch on a touch sensor on the HMD), a button press (e.g., a press on a button on the HMD), a head gesture (detected by camera 22A and/or position and motion sensors 24A), a hand gesture (e.g., detected by camera 22A), a verbal command (e.g., detected by microphone 32A), a gaze input detected by gaze tracking sensor 26A (e.g., dwelling on a particular color for longer than a threshold time), etc. When the input is provided to HMD 10A, the HMD may transmit information to electronic device 10B indicating that the selection has occurred and/or identifying the selected color.

In the example of FIGS. 6-8, multiple sampled colors are presented at a time. The user may therefore provide input selecting one of the colors that is currently being presented. For example, the user may select one of the user interface elements 82 on display 18B (with the color of the selected user interface element being used as the selected color) or may select one of the user interface elements 80 on display 18A (with the color of the selected user interface element being used as the selected color). The input may be provided to electronic device 10B and/or HMD 10A as described in the previous paragraph.

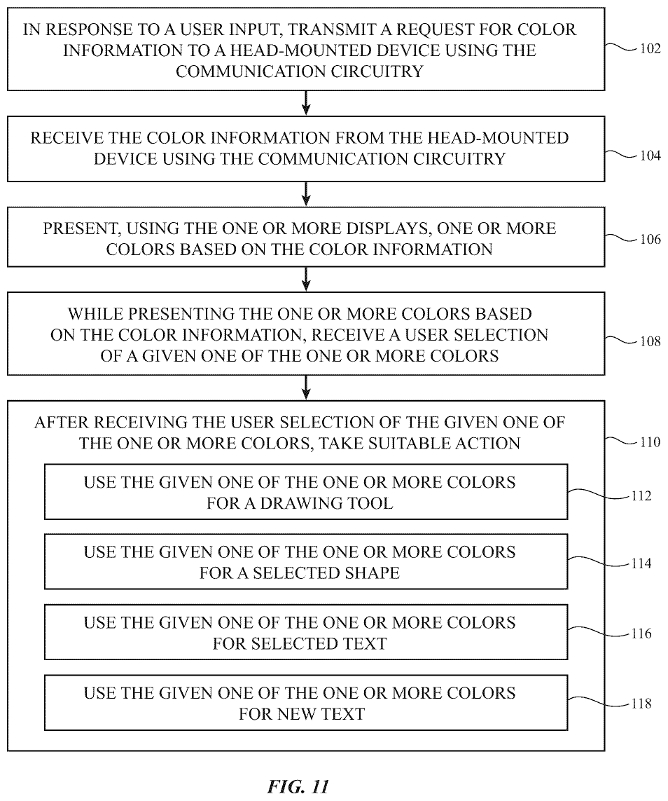

FIG. 11 is a flowchart of an illustrative method for operating an electronic device that is paired with a head-mounted device. During the operations of block 102, electronic device 10B (which may be a cellular telephone, tablet computer, laptop computer, etc.) may, in response to a user input, transmit a request for color information to a paired head-mounted device 10A using communication circuitry 56B. It is noted that before the operations of block 102, display 18B on electronic device 10B may display a color picker that includes a grid of default colors (as shown in FIG. 2). The content displayed on display 18B may include an icon used to trigger an HMD-based color picker mode (e.g., user interface element 64 in FIG. 2). The input received at block 102 may include a selection of the icon (e.g., using touch input, a mouse click, a keyboard press, etc.), a verbal command, or another desired user input.

After transmitting the request for color information during the operations of block 102, the electronic device 10B may receive the color information from head-mounted device 10A using communication circuitry 56B during the operations of block 104. The color information received during the operations of block 104 may include real-time color information obtained by head-mounted device 10A. The real-time color information may identify one color at a time. The real-time color information may identify a first color at a first time and a second color that is different than the first color at a second time subsequent to the first time.

Instead of or in addition to the real-item color information, the color information received during the operations of block 104 may include historical color information. The historical color information may include multiple colors sampled by head-mounted device 10A before the request for color information was transmitted at block 102.

During the operations of block 106, electronic device 10B may present, using display 18B, one or more colors based on the color information. Presenting the one or more colors may include presenting a user interface element with a color that is based on the real-time color information from block 104 (as shown in FIGS. 3B, 4B, and 5B). The color of the user interface element may be a first color at a first time, a second color that is different than the first color at a second time subsequent to the first time, etc.

Presenting the one or more colors at block 106 may include presenting multiple user interface elements, each user interface element having an associated color from the received color information. As shown in FIGS. 6A, 7A, and 8A, display 18B may present multiple user interface elements 82 that each have a unique color sampled by head-mounted device 10A.

During the operations of block 108, while presenting the one or more colors based on the color information, electronic device 10B may receive a user selection of a given one of the one or more colors. The user selection may be received at electronic device 10B (e.g., by an input component in electronic device 10B) or at head-mounted device 10A (e.g., by an input component in HMD 10A). When the user selection is detected by an input component in HMD 10A, the HMD may transmit the user selection information to electronic device 10B using communication circuitry 56A. The user selection may be detected by electronic device 10B using a touch sensor, button, mouse, keyboard, microphone, etc.

During the operations of block 110, after receiving the user selection of the given one of the one or more colors, electronic device 10B may take suitable action. In general, the electronic device 10B may use the selected color for any desired functionality within the electronic device. As some examples, electronic device 10B may use the given one of the one or more colors for a drawing tool (as in block 112), may use the given one of the one or more colors for a selected shape (as in block 114), may use the given one of the one or more colors for selected text (as in block 116), and/or may use the given one of the one or more colors for new text (as in block 118). These examples are merely illustrative. The HMD-based color picker may be used to select a color any time the user has the capability of selecting a color while operating electronic device 10B.

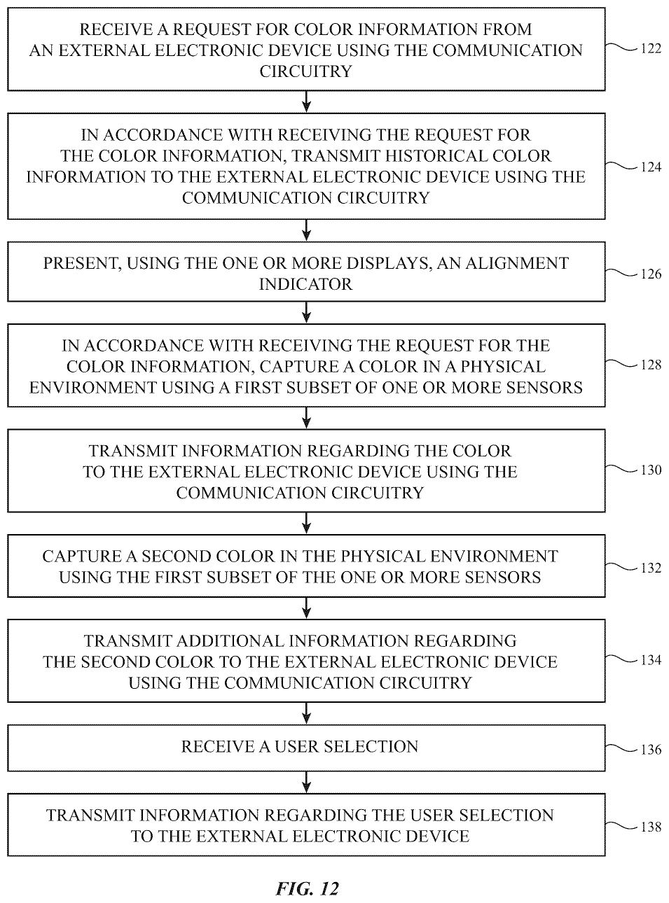

FIG. 12 is a flowchart of an illustrative method for operating a head-mounted device that is paired with an external electronic device. During the operations of block 122, head-mounted device 10A may receive, using communication circuitry 56A, a request for color information from external electronic device 10B (which may be a cellular telephone, tablet computer, laptop computer, etc.).

In accordance with receiving the request for the color information, head-mounted device 10A may transmit historical color information to the external electronic device using communication circuitry 56A during the operations of block 124. The historical color information may include one or more colors recently identified in the physical environment of head-mounted device 10A (e.g., by cameras 22A) before the request was received at block 122.

Additionally, during the operations of block 126, head-mounted device 10A may present, using display 18A, an alignment indicator. The alignment indicator may be a visual indicator that identifies a location in the physical environment that is sampled for color information. The alignment indictor may be a head-locked alignment indicator, body-locked alignment indicator, or gaze-locked alignment indicator. The operations of block 126 may be performed in accordance with receiving the request for the color information.

During the operations of block 128, head-mounted device 10A may, in accordance with receiving the request for the color information, identify a color in a physical environment using a first subset of one or more sensors. In particular, the color in the physical environment may be identified (captured) using one or more of cameras 22A. One or more of cameras 22A may be turned on (or have a sampling frequency increased) at block 128. The identified color may be the color that is aligned with the alignment indicator from block 126. The user may optionally provide a user input to indicate that the color currently aligned with the alignment indicator should be sampled.

Identifying the color in the physical environment (during the operations of block 128) may include averaging across multiple samples to improve accuracy. If desired, position and motion sensors 24A may be used to determine head movements during the multiple samples (so that the same point may be repeatedly sampled even when there are head movements).

Head-mounted device 10A may have flicker detection capabilities that allow the head-mounted device to detect pulsed lights (e.g., LEDs) in the physical environment. When head-mounted device 10A has flicker detection capabilities, the head-mounted device may select a shutter speed for color sampling during the operations of block 128 that mitigates impact on the sampled color from the pulsed LEDs.

The example of sampling color information during the operations of block 128 is merely illustrative. If desired, one or more additional material properties such as reflection, texture, and/or diffusion may be sampled during the operations of block 128.

During the operations of block 130, head-mounted device 10A may transmit information regarding the color identified at block 128 to external electronic device 10B using communication circuitry 56A. During the operations of block 130, head-mounted device 10A may transmit additional information regarding material properties such as reflection, texture, and/or diffusion to external electronic device 10B if desired.

The operations of block 128 and/or block 130 may include correcting for the white point of the physical environment surrounding head-mounted device 10A and/or external electronic device 10B. Data from one or more sensors in head-mounted device 10A (e.g., one or more cameras 22A, an ambient light sensor in the head-mounted device, etc.) and/or one or more sensors in external electronic device 10B (e.g., one or more cameras 22B, an ambient light sensor in external electronic device 10B, etc.) may be used to calculate the white point of the space around the sampled color from block 128. The identified color from block 128 may be compensated for the detected white point if desired.

The operations of block 128 and/or 130 may include updating sampling properties based on color blindness settings of head-mounted device 10A and/or external electronic device 10B.

Next, during the operations of block 132, head-mounted device 10A may identify a second color in the physical environment using the first subset of one or more sensors. In particular, the second color in the physical environment may be identified using one or more of cameras 22A. The second identified color may be a second color that is aligned with the alignment indicator from block 126 at a time subsequent to the identification of the first color in block 128.

During the operations of block 134, head-mounted device 10A may transmit information regarding the second color identified at block 132 to external electronic device 10B using communication circuitry 56A.

It is noted that at any time during the operations of blocks 126, 128, 130, 132, and 134 head-mounted device 10A may optionally display one or more user interface elements identifying the sampled colors. As one example (similar to as shown in FIGS. 3C, 4C, and 5C), a user interface element having the first color may be presented on display 18A after the first color is identified during the operations of block 128. The user interface element may then be changed from the first color to the second color after the second color is identified during the operations of block 132. As another example (similar to as shown in FIGS. 6B, 7B, and 8B), a first user interface element having the first color may be presented on display 18A after the first color is identified during the operations of block 128. A second user interface element having the second color may be displayed in addition to the first user interface element after the second color is identified during the operations of block 132.

During the operations of block 136, head-mounted device 10A may receive a user selection selecting one of the colors identified using the head-mounted device. The user selection may be detected by any input components in head-mounted device 10A (e.g., a touch sensor, a button, a microphone, a gaze tracking sensor, etc.). After the user selection is detected, head-mounted device 10A may transmit the user selection information to electronic device 10B using communication circuitry 56A during the operations of block 138. The transmitted user selection information may include information identifying that a selection has occurred as well as identifying the color that was selected.

The order of operations presented in FIGS. 11 and 12 are merely illustrative. In general, the operations of FIGS. 11 and 12 may be performed in any order and multiple operations may be performed at the same time.

It is noted that, herein, colors may be encoded according any desired scheme during the wireless transmission of color information. For example, colors may be encoded using hexadecimal (HEX) color codes, RGB (red, blue, green) values, CMYK (cyan magenta, yellow, black) values, HSV (hue, saturation, value) values, HSL (hue, saturation, lightness) values, and/or any other type of color encoding scheme.

In the aforementioned examples, head-mounted device 10A provides color data to an external electronic device. However, the concepts described herein may also apply to other types of attributes that are selected by a user. As a specific example, the concepts herein may apply to font selection. A user may operate a word processing application on electronic device 10B. While operating the word processing application, the user may wish to select a font in the word processing application. The word processing application may have a menu with default fonts for selection. This menu may also include a user interface element (e.g., similar to user interface element 64 in FIG. 2) that triggers an HMD-based font selection when selected. In response to the HMD-based font selection being triggered, head-mounted device 10A may transmit historical font information (e.g., fonts recently identified in the physical environment of HMD 10A) or may sample fonts in the physical environment in real time using cameras 22A (and subsequently transmit the real time font information to electronic device 10B).

As described above, one aspect of the present technology is the gathering and use of information such as sensor information. The present disclosure contemplates that in some instances, data may be gathered that includes personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, username, password, biometric information, or any other identifying or personal information.

The present disclosure recognizes that the use of such personal information, in the present technology, can be used to the benefit of users. For example, the personal information data can be used to deliver targeted content that is of greater interest to the user. Accordingly, use of such personal information data enables users to have control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of or access to certain health data may be governed by federal and/or state laws, such as the Health Insurance Portability and Accountability Act (HIPAA), whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to provide certain types of user data. In yet another example, users can select to limit the length of time user-specific data is maintained. In addition to providing “opt in” and “opt out” options, the present disclosure contemplates providing notifications relating to the access or use of personal information. For instance, a user may be notified upon downloading an application (“app”) that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of information that may include personal information data to implement one or more various disclosed embodiments, the present disclosure also contemplates that the various embodiments can also be implemented without the need for accessing personal information data. That is, the various embodiments of the present technology are not rendered inoperable due to the lack of all or a portion of such personal information data.

The foregoing is merely illustrative and various modifications can be made to the described embodiments. The foregoing embodiments may be implemented individually or in any combination.

What is claimed is:

1. An electronic device comprising:
one or more displays;
communication circuitry;
one or more processors; and
memory storing instructions configured to be executed by the one or more processors, the instructions for:
in response to a user input, transmitting a request for color information to a head-mounted device using the communication circuitry;
after transmitting the request, receiving the color information from the head-mounted device using the communication circuitry; and
presenting, using the one or more displays, one or more colors based on the color information.

2. The electronic device defined in claim 1, wherein the color information identifies a first color at a first time and identifies a second color that is different than the first color at a second time that is subsequent to the first time.

3. The electronic device defined in claim 2, wherein presenting, using the one or more displays, the one or more colors based on the color information comprises:
presenting the first color after the first time and before the second time; and
presenting both the first color and the second color after the second time.

4. The electronic device defined in claim 1, wherein the color information comprises historical color information and wherein the historical color information comprises multiple colors identified by the head-mounted device over a time period preceding the user input.

5. The electronic device defined in claim 1, wherein presenting, using the one or more displays, the one or more colors based on the color information comprises presenting one or more interface elements and wherein each interface element of the one or more interface elements has a respective color of the one or more colors.

6. The electronic device defined in claim 1, wherein the instructions further comprise instructions for:
while presenting the one or more colors based on the color information, receiving a first user selection of a given one of the one or more colors, wherein the first user selection is received at the electronic device or at the head-mounted device; and
after receiving the first user selection of the given one of the one or more colors, using the given one of the one or more colors for a drawing tool, for a selected shape, for selected text, or for new text.

7. The electronic device defined in claim 1, wherein the color information is compensated for a white point of a physical environment of the electronic device.

8. A method of operating an electronic device that comprises one or more displays and communication circuitry, the method comprising:
in response to a user input, transmitting a request for color information to a head-mounted device using the communication circuitry;
after transmitting the request, receiving the color information from the head-mounted device using the communication circuitry; and
presenting, using the one or more displays, one or more colors based on the color information.

9. The method defined in claim 8, wherein the color information identifies a first color at a first time and identifies a second color that is different than the first color at a second time that is subsequent to the first time.

10. The method defined in claim 9, wherein presenting, using the one or more displays, the one or more colors based on the color information comprises:
presenting the first color after the first time and before the second time; and
presenting both the first color and the second color after the second time.

11. The method defined in claim 8, wherein the color information comprises historical color information and wherein the historical color information comprises multiple colors identified by the head-mounted device over a time period preceding the user input.

12. The method defined in claim 8, wherein presenting, using the one or more displays, the one or more colors based on the color information comprises presenting one or more interface elements and wherein each interface element of the one or more interface elements has a respective color of the one or more colors.

13. The method defined in claim 8, further comprising:
while presenting the one or more colors based on the color information, receiving a first user selection of a given one of the one or more colors, wherein the first user selection is received at the electronic device or at the head-mounted device; and
after receiving the first user selection of the given one of the one or more colors, using the given one of the one or more colors for a drawing tool, for a selected shape, for selected text, or for new text.

14. The method defined in claim 8, wherein the color information is compensated for a white point of a physical environment of the electronic device.

15. A non-transitory computer-readable storage medium storing one or more programs configured to be executed by one or more processors of an electronic device that comprises one or more displays and communication circuitry, the one or more programs including instructions for:
in response to a user input, transmitting a request for color information to a head-mounted device using the communication circuitry;
after transmitting the request, receiving the color information from the head-mounted device using the communication circuitry; and
presenting, using the one or more displays, one or more colors based on the color information.

16. The non-transitory computer-readable storage medium defined in claim 15, wherein the color information identifies a first color at a first time and identifies a second color that is different than the first color at a second time that is subsequent to the first time.

17. The non-transitory computer-readable storage medium defined in claim 16, wherein presenting, using the one or more displays, the one or more colors based on the color information comprises:
presenting the first color after the first time and before the second time; and
presenting both the first color and the second color after the second time.

18. The non-transitory computer-readable storage medium defined in claim 15, wherein the color information comprises historical color information and wherein the historical color information comprises multiple colors identified by the head-mounted device over a time period preceding the user input.

19. The non-transitory computer-readable storage medium defined in claim 15, wherein presenting, using the one or more displays, the one or more colors based on the color information comprises presenting one or more interface elements and wherein each interface element of the one or more interface elements has a respective color of the one or more colors.

20. The non-transitory computer-readable storage medium defined in claim 15, wherein the instructions further comprise instructions for:
while presenting the one or more colors based on the color information, receiving a first user selection of a given one of the one or more colors, wherein the first user selection is received at the electronic device or at the head-mounted device; and
after receiving the first user selection of the given one of the one or more colors, using the given one of the one or more colors for a drawing tool, for a selected shape, for selected text, or for new text.

21. The non-transitory computer-readable storage medium defined in claim 15, wherein the color information is compensated for a white point of a physical environment of the electronic device.
